(19) United States
(12) Patent Application Publication
(10) Pub. No.: US 2018/0341155 A1
(43) Pub. Date: Nov. 29, 2018

(54) FREE-FORM DISPLAY SCREEN AND PIXEL UNIT STRUCTURE THEREOF

(71) Applicant: SHENZHEN CHINA STAR OPTOELECTRONICS TECHNOLOGY CO., LTD., Shenzhen, Guangdong (CN)

(72) Inventors: Hefeng Liu, Shenzhen, Guangdong (CN); Zhao Wang, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,330

(22) PCT Filed: Jan. 13, 2017
(86) PCT No.: PCT/CN2017/071036

§ 371 Date: Nov. 16, 2017

(30) Foreign Application Priority Data
Jul. 6, 2016 (CN) 201610527659.1

(51) Int. Cl. G02F 1/1343; G02F 1/1368; G02F 1/1362

(52) U.S. Cl. CPC G02F 1/134336; G02F 1/1368; G02F 1/13454; G02F 2001/134345; G02F 1/136213; G02F 1/136286

(57) ABSTRACT

Disclosed are a free-form display screen and a pixel unit structure thereof. The pixel unit structure of the free-form display screen includes three sub-pixels, and each of the sub-pixels includes a thin-film transistor. Gates of thin-film transistors in the three sub-pixels are connected to a same scanning line. Sources of the thin-film transistors in the three sub-pixels are respectively connected to three data lines which are arranged along a longitudinal direction. The free-form display screen and the pixel unit structure thereof can be used for mass production of the free-form display screen.

### CROSS-REFERENCE TO RELATED APPLICATIONS

This application claims the priority of Chinese patent application CN201610527659.1, entitled “Free-form display screen and pixel unit structure thereof” and filed on Jul. 6, 2016, the entirety of which is incorporated herein by reference.

### FIELD OF THE INVENTION

The present disclosure relates to the technical field of display, and in particular, to a free-form display screen and a pixel unit structure thereof.

### BACKGROUND OF THE INVENTION

With the development of display technologies, liquid crystal display screens have become the most common display devices.

A free-form display screen refers to a liquid crystal display screen having a special shape and size compared with an original common liquid crystal display screen. The free-form display screen can be used in many scenes for special needs, such as indicating a bus or subway route or presenting an advertisement, due to a special structure thereof.

At present, the free-form display screen is mainly produced by cutting unqualified products in ordinary liquid crystal display screens. As shown in FIG. 1, this liquid crystal display screen is an unqualified product. The upper part is an area 110 having an unqualified display effect, and the lower part is an area 120 having a normal display effect. When the upper part having an unqualified display effect is cut off, a free-form display screen having a large width to length ratio is formed by the remaining lower part having a normal display effect, as shown in FIG.

More and more free-form display screens are demanded in the market, but qualification rates of liquid crystal display screen productions of the producers are gradually improved. Thus, demands in the market cannot be satisfied by producing the free-form display screens only by cutting the unqualified products. Although mass production of the free-form display screens can be achieved by cutting qualified liquid crystal display screens, great waste of production resources and high production costs will be caused. Accordingly, the mass production of the free-form display screens cannot be achieved with low costs in the prior art.

### SUMMARY OF THE INVENTION

The present disclosure aims to provide a free-form display screen and a pixel unit structure thereof for achieving mass production of the free-form display screen with low costs.

The present disclosure provides a pixel unit structure of a free-form display screen. The pixel unit structure of the free-form display screen includes three sub-pixels, and each of the sub-pixels includes a thin-film transistor. Gates of thin-film transistors in the three sub-pixels are connected to a same scanning line. Sources of the thin-film transistors in the three sub-pixels are respectively connected to three data lines which are arranged along a longitudinal direction.

In one embodiment, the three sub-pixels are arranged along the longitudinal direction, and the scanning line is connected to the gate of the thin-film transistor in each of the sub-pixels sequentially.

In another embodiment, the three sub-pixels are arranged along a transverse direction, and three branches of the scanning line are respectively connected to the gate of the thin-film transistor in each of the sub-pixels sequentially.

Further, each of the sub-pixels further includes a pixel electrode, a common electrode, and a common electrode line. The pixel electrode is connected to a drain of the thin-film transistor, and a liquid crystal capacitor is formed between the pixel electrode and the common electrode. A storage capacitor is formed between the pixel electrode and the common electrode line.

Preferably, the three sub-pixels are respectively a red sub-pixel, a green sub-pixel, and a blue sub-pixel.

The present disclosure further provides a free-form display screen, which comprises several pixel units arranged in an array. Each of the pixel units has an above-mentioned pixel unit structure.

Preferably, a transverse length of the free-form display screen is greater than a longitudinal length of the free-form display screen.

Further, the free-form display screen comprises an array substrate, a color filter substrate, and a liquid crystal layer filled between the array substrate and the color filter substrate.

Preferably, a gate driving circuit is arranged on the array substrate in a GOA manner.

Further, a data driving circuit board is arranged at one side o e array substrate for outputting data signals to respective pixel units.

Preferably, the data driving circuit board is arranged at a short edge side of the array substrate.

The present disclosure brings about the following beneficial effects. The pixel unit structure of the free-form display screen provided in the present disclosure comprises three sub-pixels. The gates of the three thin-film transistors respectively located in the three sub-pixels are connected to the same scanning line. The sources of the three thin-film transistors are respectively connected to three data lines which are arranged along the longitudinal direction. When such a pixel unit structure is applied in the free-form display screen, a sum of the data lines needed for the free-form display screen is three times of a sum of the pixel units in the longitudinal direction, and each data line can control a full pixel unit row.

When the above-mentioned pixel unit structure is applied to the free-form display screen which is very long in the transverse direction and very short in the longitudinal direction, since the free-form display screen has a small number of pixel units in the longitudinal direction, a small number of data lines are needed. Moreover, since the free-form display screen has a large number of pixels units in the transverse direction, each data line can control many sub-pixels. Thus, by using the pixel unit structure provided in the present disclosure, the number of the data lines in the free-form display screen can be greatly reduced, and each data line can control as many sub-pixels as possible. Therefore, the free-form display screen can be produced directly and conveniently rather than depending on cutting unqualified products, and thereby mass production of the free-form display screen with low costs can be achieved.

Other features and advantages of the present disclosure will be further explained in the following description, and will partly become self-evident therefrom; or be understood through the implementation of the present disclosure. Objectives and advantages of the present disclosure will be achieved and obtained through structures specifically pointed out in the description claims, and the accompanying drawings.

### BRIEF DESCRIPTION OF THE DRAWINGS

In order to clearly explain the technical solutions in embodiments of the present disclosure, a brief introduction is made to the accompanying drawings used in descriptions of the embodiments. In the accompanying drawings:

FIG. 1 schematically shows a manner for producing a free-form display screen in the prior art;

FIG. 2 schematically shows a structure of the free-form display screen in the prior art;

FIG. 3 schematically shows a pixel unit structure of a free-form display screen in embodiment 1 of the present disclosure;

FIG. 4 shows a structure of the free-form display screen in embodiment of he present disclosure;

FIG. 5 schematically shows a pixel unit structure of a free-form display screen in embodiment 2 of the present disclosure; and

FIG. 6 shows a structure of the free-form display screen in embodiment 2 of the present disclosure.

### DETAILED DESCRIPTION OF THE EMBODIMENTS

The implementation manner of the present disclosure will be explained in detail below with reference to the accompanying drawings and the embodiments, so that one can fully understand how the present disclosure solves the technical problem and achieves the technical effects through the technical means, thereby implementing the same. It should be noted that as long as there is no conflict, any of the embodiments and any of the technical features thereof may be combined with one another, and the technical solutions obtained therefrom all fall within the scope of the present disclosure.

A pixel unit structure of a free-form display screen is provided in embodiments of the present disclosure. The pixel unit structure comprises three sub-pixels, and each of the sub-pixels includes a thin-film transistor. Gates of thin-film transistors in the three sub-pixels are connected to a same scanning line. Sources of the thin-film transistors in the three sub-pixels are respectively connected to three data lines which are arranged along a longitudinal direction.

### Embodiment 1

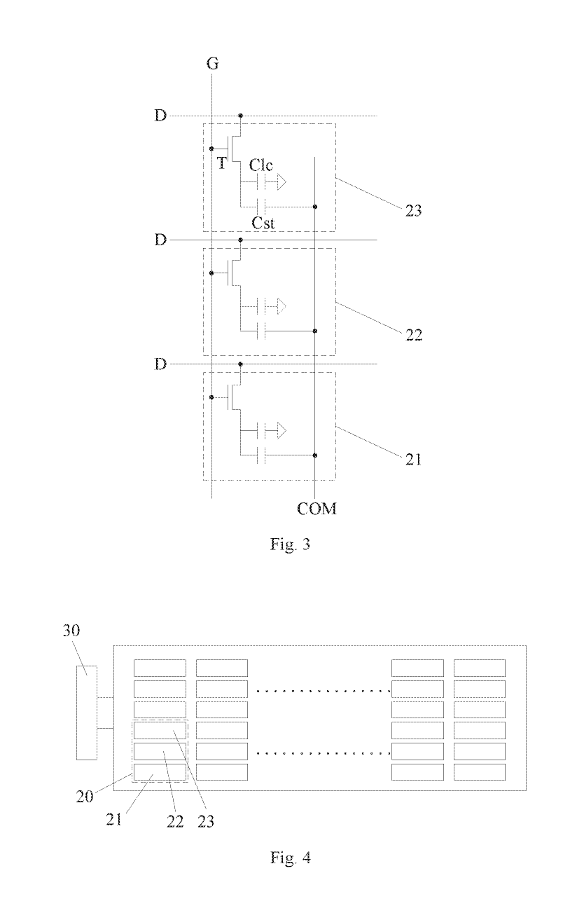

As shown in FIG. 3, the pixel unit structure provided in the present embodiment comprises three sub-pixels 21, 22, and 23 which are arranged along the longitudinal direction. Each of the sub-pixels comprises a thin-film transistor T arranged therein. Gates of thin-film transistors T in the three sub-pixels 21, 22, and 23 are connected to a same scanning line G, and the scanning line G is connected to the gates of the thin-film transistors T in the three sub-pixels 21, 22, and 23 sequentially. Sources of the thin-film transistors T in the three sub-pixels 21, 22, and 23 are respectively connected to three data lines D. In the present embodiment, the three sub-pixels 21, 22, and 23 are respectively a red sub-pixel, a green sub-pixel, and a blue sub-pixel.

Furthermore, each of the sub-pixels further includes a pixel electrode and a common electrode. The pixel electrode is connected to a drain of the thin-film transistor T, and a liquid crystal capacitor Clc is formed between the pixel electrode and the common electrode. Each of the sub-pixels further includes a common electrode line COM, and a storage capacitor Cst is formed between the pixel electrode and the common electrode line.

A free-form display screen is further provided in the present embodiment. As shown in FIG. 4, a transverse length of the free-form display screen provided in the present embodiment is greater than a longitudinal length thereof. That is, the free-form display screen provided in the present embodiment has a large width to length ratio.

The free-form display screen comprises several pixel units 20 arranged in an array, and each of the pixel units has the above pixel unit structure provided in the present embodiment. That is, three sub-pixels are arranged along the longitudinal direction, and three data lines corresponding to the three sub-pixels are also arranged along the longitudinal direction. When such a pixel unit structure is used, a sum of the data lines needed for the free-form display screen is three times of a sum of the pixel units in the longitudinal direction, and each data line can control an entire row of sub-pixels.

Since the free-form display screen has a small number of pixel units in the longitudinal direction, a small number of data lines are needed. Moreover, since the free-form display screen has a large number of pixels units in a transverse direction, each data line can control many sub-pixels.

However, in a free-form display screen in the prior art, as shown in Fig, each pixel unit 10 is made up of three sub-pixels 11, 12, and 13. The three sub-pixels 11, 12, and 13 are connected to a same scanning line, and are respectively connected to three data lines. Thus, a sum of the data lines needed for the free-form display screen in the prior art is three times of a sum of the pixel units in a transverse direction, and each data line can control an entire column of sub-pixels. Since the free-form display screen has a large number of pixel units in the transverse direction and has a small number of pixel units in a longitudinal direction, a large number of data lines are needed. However, each data line controls a small number of sub-pixels, and this causes low use efficiency of the data lines and resource waste of the data lines.

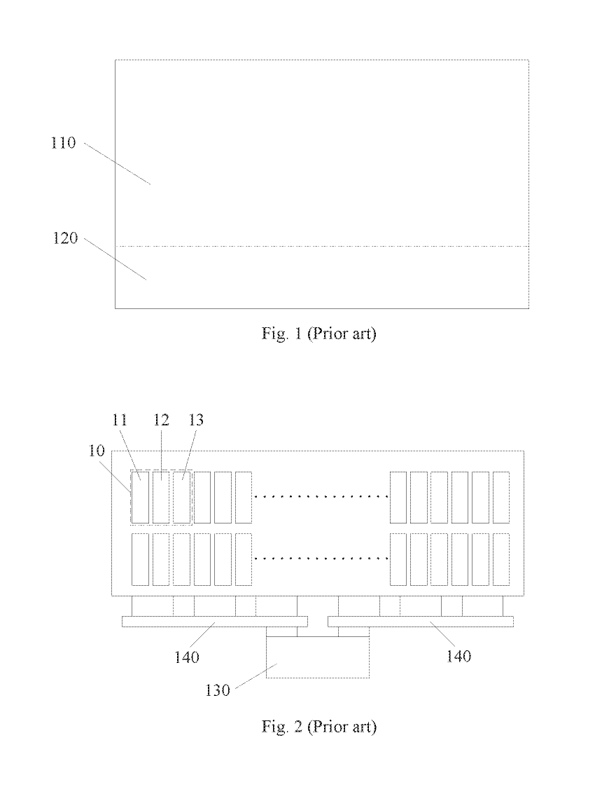

Moreover, since there are a large number of data lines in the free-form display screen in the prior art, a larger quantity of more complex data driving circuits are needed. It can be seen from FIG. 2 that, a data processing chip 130 is connected to two data driving circuit boards 140 at a bottom side of the free-form display screen.

Besides, in the free-form display screen in the prior art, each scanning line is used to control an entire row of sub-pixels. Since there are a large number of pixel units in the transverse direction, each scanning line controls a large number of sub-pixels. :Moreover, the scanning line is very long, and thus some of the sub-pixels may be charged insufficiently due to a time delay on the scanning line, which affects display effects of the free-form display screen.

Compared with the prior art, the pixel unit structure provided in the present embodiment is used in the free-form display screen provided in the present embodiment, which can greatly decrease the number of the data lines in the free-form display screen and enable each data line to control as many sub-pixels as possible. Accordingly, the use efficiency of the data lines can be significantly improved, and the resource waste of the data lines can be avoided. Thus, the free-form display screen can be produced directly and conveniently by using the technical solution provided in the present embodiment rather than depending on cutting unqualified products, and thereby mass production of the free-form display screen with low costs can be achieved.

Furthermore, the free-form display screen provided in the present embodiment comprises an array substrate and a color filter substrate, and a liquid crystal layer filled between the array substrate and the color filter substrate. As a preferred solution, a gate driving circuit can be arranged on the array substrate in a manner of gate driver on array (GOA). The gate driving circuit is manufactured on the array substrate by means of a GOA technology, so that the gate driving circuit can be manufactured on an edge area of the array substrate by using an original process for manufacturing the array substrate so as to replace an original externally connected chip. Thus, by using the GOA technology, a process of bonding a driving chip is not needed, which can improve productivity and reduce production costs, and a frame width of a display device can be reduced.

In addition, in the present embodiment, the free-form display screen has a small number of pixel units in the longitudinal direction, and thus each scanning line controls a small number of sub-pixels. Moreover, the scanning line is very short, and thus it can be avoided that some of the sub-pixels are insufficiently charged due to the time delay on the scanning line, which ensures the display effects of the free-form display screen.

As shown in FIG. 4, in the present embodiment, a data driving circuit board 30 is arranged at one side of the array substrate for outputting data signals to each of the pixel units. Preferably, the data driving circuit board 30 is arranged at a short edge side of the array substrate.

Since a small number of data lines are needed for the free-form display screen provided in the present embodiment, only one data driving circuit board 30 needs to be arranged for outputting the data signals. Compared with the prior art, fewer circuit boards are needed and a total area of the circuit boards is reduced in the present embodiment. Accordingly, fewer devices are needed, and production costs of the free-form display screen are reduced.

### Embodiment 2

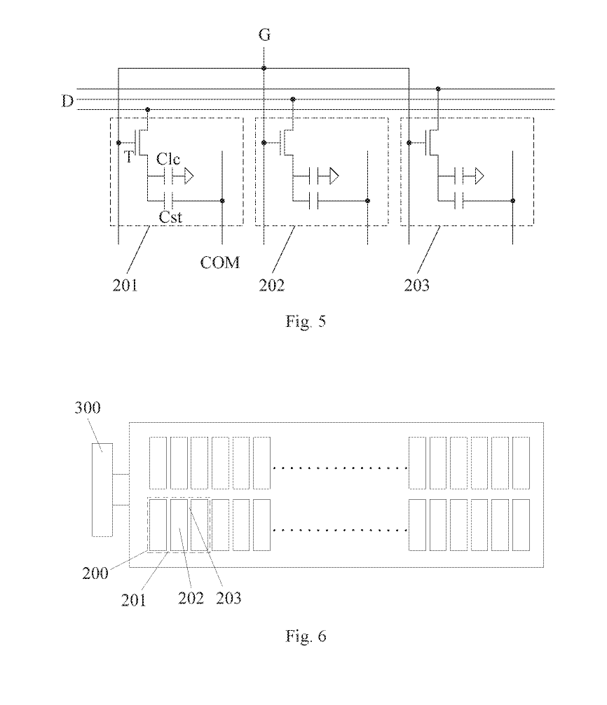

As shown in FIG. 5, the pixel unit structure provided in the present embodiment comprises three sub-pixels 201, 202, and 203 which are arranged in a transverse direction. Each of the sub-pixels comprises a thin-film transistor T arranged therein. Gates of thin-film transistors T in the three sub-pixels 201, 202, and 203 are connected to a same scanning line G. Specifically, the scanning line G has three branches, and the branches are respectively connected to the gates of the thin-film transistors T in the three sub-pixels 201, 202, and 203. Sources of the thin-film transistors T in the three sub-pixels 201, 202, and 203 are respectively connected to three data lines D, and the three data lines D are located at a same side of the three sub-pixels 201, 202, and 203. In the present embodiment, the three sub-pixels 201, 202, and 203 are respectively a red sub-pixel, a green sub-pixel, and a blue sub-pixel.

Furthermore, each of the sub-pixels further comprises a pixel electrode and a common electrode. The pixel electrode is connected to a drain of the thin-film transistor T, and a liquid crystal capacitor Clc is formed between the pixel electrode and the common electrode. Each of the sub-pixels further comprises a common electrode line COM, and a storage capacitor Cst is formed between the pixel electrode and the common electrode line.

A free-form display screen is further provided in the present embodiment. As shown in FIG. 6, a transverse length of the free-form display screen provided in the present embodiment is greater than a longitudinal length thereof. That is, the free-form display screen provided in the present embodiment has a large width to length ratio.

The free-form display screen comprises several pixel units 200 which are arranged in an array, and each of the pixel units has the above pixel unit structure provided in the present embodiment. That is, the three sub-pixels are arranged in the transverse direction, and the three data lines corresponding to the three sub-pixels are arranged in the longitudinal direction. When such a pixel unit structure is used, a sum of the data lines needed for the free-form display screen is three times of a sum of the pixel units in the longitudinal direction, and each data line can control an entire row of pixel units.

Since the free-form display screen has a small number of pixel units in the longitudinal direction, a small number of data lines are needed. Moreover, since the free-form display screen has a large number of pixels units in the transverse direction, each data line can control many sub-pixels.

Compared with the prior art, the pixel unit structure provided in the present embodiment is used in the free-form display screen provided in the present embodiment, which can greatly decrease the number of the data lines in the free-form display screen and enable each data line to control as many sub-pixels as possible. Accordingly, the use efficiency of the data lines can be significantly improved, and the resource waste of the data lines can be avoided. Thus, the free-form display screen can be produced directly and conveniently by using the technical solution provided in the present embodiment rather than depending on cutting unqualified products, and thereby mass production of the free-form display screen with low costs can be achieved.

Furthermore, the free-form display screen provided in the present embodiment comprises an array substrate and a color filter substrate, and a liquid crystal layer filled between the array substrate and the color filter substrate. As a preferred solution, a gate driving circuit can be arranged on the array substrate in a manner of gate driver on array (GOA). The gate driving circuit is manufactured on the array substrate by means of a GOA technology, so that the gate driving circuit can be manufactured on an edge area of the array substrate by using an original process for manufacturing the array substrate so as to replace an original externally connected chip. Thus, by using the GOA technology, a process of bonding a driving chip is riot needed, which can improve productivity and reduce production costs, and a frame width of a display device can be reduced.

In addition, in the present embodiment, the free-form display screen has a small number of pixel units in the longitudinal direction, and thus each scanning line controls a small number of sub-pixels. Moreover, the scanning line is very short, and thus it can be avoided that some of the sub-pixels are insufficiently charged due to a time delay on the scanning line, which ensures the display effects of the free-form display screen.

As shown in Fig, 6, a data driving circuit board 300 is arranged at one side of the array substrate in the present embodiment for outputting data signals to each of the pixel units. Preferably, the data driving circuit board 300 is arranged at a short edge side of the array substrate.

Since a small number of data lines are needed for the free-form display screen provided in the present embodiment, only one data driving circuit board 300 needs to be arranged for outputting the data signals. Compared with the prior art, fewer circuit boards are needed and a total area of the circuit boards is reduced in the present embodiment. Accordingly, fewer devices are needed, and production costs of the free-form display screen are reduced.

Although embodiments of the present disclosure are provided as above, the above embodiments are described only for better understanding, rather than restricting the present disclosure. Anyone skilled in the art can make amendments to the implementing forms or details without departing from the spirit and scope of the present disclosure. The scope of the present disclosure should be subject to the scope defined in the claims.

1. A pixel unit structure of a free-form display screen, wherein the pixel unit structure comprises three sub-pixels, each of the sub-pixels including a thin-film transistor,
wherein gates of thin-film transistors in the three sub-pixels are connected to a same scanning line, and
wherein sources of the thin-film transistors in the three sub-pixels are respectively connected to three data lines which are arranged along a longitudinal direction.

2. The pixel unit structure according to claim 1, wherein the three sub-pixels are arranged along the longitudinal direction, and the scanning line is connected to the gate of the thin-film transistor in each of the sub-pixels sequentially.

3. The pixel unit structure according to claim 1, wherein the three sub-pixels are arranged along a transverse direction, and three branches of the scanning line are respectively connected to the gate of the thin-film transistor in each of the sub-pixels sequentially.

4. The pixel unit structure according to claim 1, wherein each of the sub-pixels further includes a pixel electrode, a common electrode, and a common electrode line,
wherein the pixel electrode is connected to a drain of the thin-film transistor, and a liquid crystal capacitor is formed between the pixel electrode and the common electrode: and
wherein a storage capacitor is formed between the pixel electrode and the common electrode line.

5. A free-form display screen, which comprises several pixel units arranged in an array, each of the pixel units having a pixel unit structure of the free-form display screen,
wherein the pixel unit structure of the free-form display screen comprises three sub-pixels, each of the sub-pixels including a thin-film transistor,
wherein gates of thin-film transistors in the three sub-pixels are connected to a same scanning line, and
wherein sources of the thin-film transistors in the three sub-pixels are respectively connected to three data lines which are arranged along a longitudinal direction.

6. The free-form display screen according to claim 5, wherein the three sub-pixels are arranged along the longitudinal direction, and the scanning line is connected to the gate of the thin-film transistor in each of the sub-pixels sequentially.

7. The free-form display screen according to claim 5, wherein the three sub-pixels are arranged along a transverse direction, and three branches of the scanning line are respectively connected to the gate of the thin-film transistor in each of the sub-pixels sequentially.

8. The free-form display screen according to claim 5, wherein each of the sub-pixels further includes a pixel electrode, a common electrode, and a common electrode line,
wherein the pixel electrode is connected to a drain of the thin-film transistor, and a liquid crystal capacitor is formed between the pixel electrode and the common electrode: and
wherein a storage capacitor is formed between the pixel electrode and the common electrode line.

9. The free-form display screen according to claim 5, wherein a transverse length of the free-form display screen is greater than a longitudinal length of the free-form display screen.

10. The free-form display screen according to claim 6, wherein a transverse length of the free-form display screen is greater than a longitudinal length of the free-form display screen.

11. The free-form display screen according to claim 7, wherein a transverse length of the free-form display screen is greater than a longitudinal length of the free-form display screen.

12. The free-form display screen according to claim 8, wherein a transverse length of the free-form display screen is greater than a longitudinal length of the free-form display screen.

13. The free-form display screen according to claim 5, comprising an array substrate, a color filter substrate, and a liquid crystal layer filled between the array substrate and the color filter substrate.

14. The free-form display screen according to claim 6, comprising an array substrate, a color filter substrate, and a liquid crystal layer tilled between the array substrate and the color filter substrate.

15. The free-form display screen according to claim 7, comprising an array substrate, a color filter substrate, and a liquid crystal layer filled between the array substrate and the color filter substrate.

16. The free-form display screen according to claim 8, comprising an array substrate, a color filter substrate, and a liquid crystal layer filled between the array substrate and the color filter substrate.

17. The free-form display screen according to claim 13, wherein a gate driving circuit is arranged on the array substrate in a GOA manner.

18. The free-form display screen according to claim 14, wherein a gate driving circuit is arranged on the array substrate in a GOA manner.

19. The free-form display screen according to claim 13, wherein a data driving circuit board is arranged at one side of the array substrate for outputting data signals to each of the pixel units.

20. The free-form display screen according to claim 19, wherein the data driving circuit board is arranged at a short edge side of the array substrate.
